(19) United States
(12) Patent Application Publication
(10) Pub. No.: US 2025/0251513 A1
(43) Pub. Date: Aug. 7, 2025

(54) Devices and Methods for In-Frame Velocity Estimation

(71) Applicant: Microvision, Inc., Redmond, WA (US)

(72) Inventors: Marco J. Nikander, Moenkeberg (DE); Clemens Wuth, Hamburg (DE)

(73) Assignee: Microvision, Inc., Redmond, WA (US)

(21) Appl. No.: 18/433,818

(22) Filed: Feb. 6, 2024

(51) Int. Cl. G01S 17/58; G01S 7/484; G01S 7/4863; G01S 17/42

(52) U.S. Cl. CPC G01S 17/58; G01S 7/484; G01S 7/4863; G01S 17/42

(57) ABSTRACT

The embodiments described herein provide systems and methods that can facilitate improved velocity estimation in light detection and ranging (LiDAR) systems and other scanning laser devices. Specifically, the systems and methods utilize laser light pulses to determine estimates of velocity for multiple measurement points in a scanned region. For example, a scanning laser device can be adapted to scan measurement points during temporally adjacent measurement subframes and generate distance measurements based on the scans made during those subframes. The scanning laser device is further adapted to interpolate distance measurements to determine distance estimates for measurement points not directly scanned during at least one of the subframes, and to compare the generated distance estimates to distance measurements taken in the other subframe to determine radial velocity estimates for corresponding measurement points based on the comparison.

### FIELD

The present disclosure generally relates to scanning laser devices and methods, and more particularly relates to light detection and ranging (LiDAR) systems and methods.

### BACKGROUND

Scanning laser devices have been developed and implemented for a wide variety of applications, including object detection. For example, light detection and ranging (LiDAR) systems have been developed for object detection and distance determination. LiDAR systems have also been used to generate 3D maps of surfaces, where the 3D maps describe the variations in depth over the surface. Such object detection, distance determination, and depth mapping have been used in a variety of applications, including navigation and control. For example, such LiDAR devices are being used in the navigation and control of autonomous vehicles, including autonomous devices used for transportation and manufacturing.

In some LiDAR applications there is a desire to further determine motion of detected objects. For example, in some vehicle applications there is a desire to detect and determine the relative motion of detected objects that may cause a safety issue with the vehicle.

Thus, there remains a continuing need for systems and methods that can provide effective determination of motion of detected objects.

### BRIEF DESCRIPTION OF THE DRAWINGS

FIG. 1A shows a schematic diagram of a scanning laser device in accordance with various embodiments;

FIGS. 1B-1E show schematic diagrams of scan patterns in accordance with various embodiments;

FIGS. 2A and 2B show flow diagrams of exemplary methods in accordance with various embodiments;

FIGS. 3A, 3B, 3C and 3D show diagrams of exemplary scan patterns in accordance with various embodiments;

FIG. 4A shows a flow diagram of exemplary methods in accordance with various embodiments;

FIG. 4B shows a schematic view of an object and laser light source in accordance with various embodiments;

FIGS. 5A and 5B shows schematic diagrams of a scanning laser device and emitter array in accordance with various embodiments; and

FIGS. 6A and 6B show schematic diagrams of a sensor array in accordance with various embodiments.

### DESCRIPTION OF EMBODIMENTS

The embodiments described herein provide systems and methods that can facilitate improved velocity estimation in light detection and ranging (LiDAR) systems and other scanning laser devices. Specifically, the systems and methods utilize laser light pulses to determine estimates of velocity for multiple measurement points in a scanned region. And in accordance with the embodiments described herein, these estimates of velocity can be made for these multiple measurement points for each scanned frame.

In one embodiment a scanning laser device is adapted to scan measurement points during first and second measurement subframes and generate distance measurements based on the scans made during those subframes. In such an embodiment the first and second subframes are temporally adjacent subframes, and thus each of the first and second subframe are part of one measurement frame. The scanning laser device is further adapted to interpolate distance measurements to determine distance estimates for measurement points not directly scanned during at least one of the subframes, and to compare the generated distance estimates to distance measurements taken in the other subframe to determine radial velocity estimates for corresponding measurement points based on the comparison.

Thus, for each scanned frame the scanning laser device can provide velocity estimates for multiple measurement points. In some embodiments, this estimation of velocity for multiple measurement points for each scanned frame can be used to discern moving objects from stationary surroundings. Furthermore, this estimation of velocity for multiple measurement points for each scanned frame can provide such velocity information with relatively low latency and high frequency. Such low latency information is of particular importance in the context of applications such autonomous driving, where the “time to interface” constitutes a critical performance indicator, and where there is a need for the determination of trajectory planning and evasive maneuvers within milliseconds.

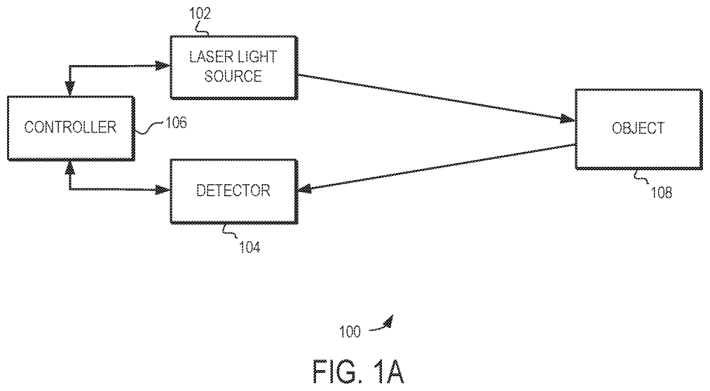

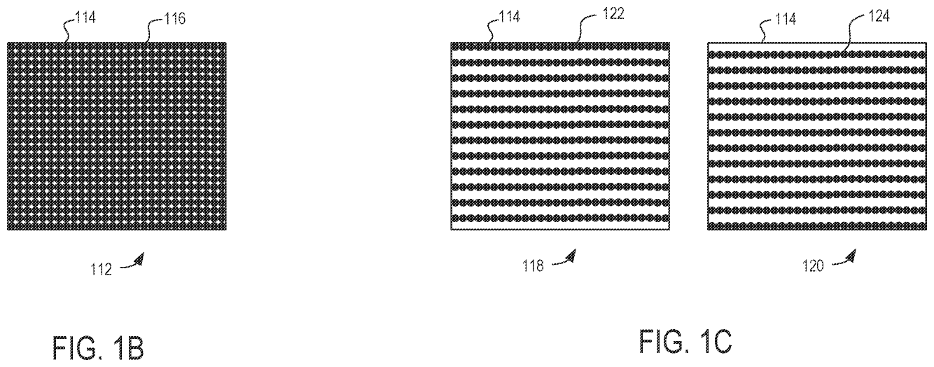

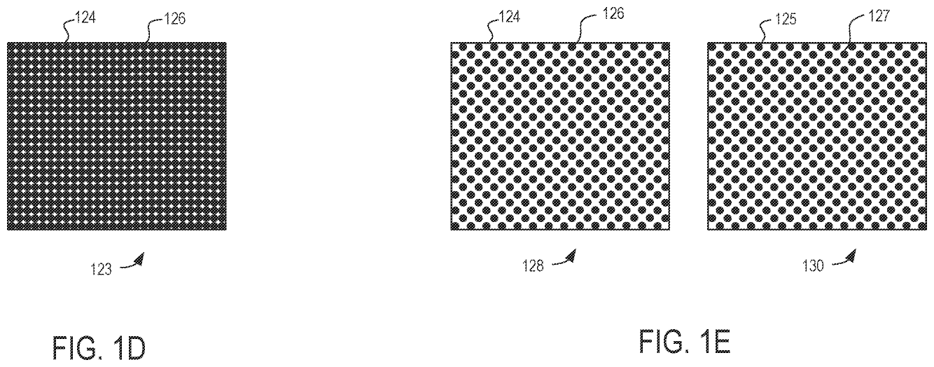

Turning now to FIG. 1A, a simplified schematic diagram of a scanning laser device 100 in accordance various embodiments is illustrated. In one embodiment, the scanning laser device 100 is a light detection and ranging (LiDAR) system used for object detection and/or 3D map generation. The scanning laser device 100 includes a laser light source 102, a detector 104, and at least one controller 106. During operation, the laser light source 102 generates pulses of laser light that are projected into a spatial region referred to as a scan field. These pulses of laser light impact objects (e.g., object 108) in the scan field at multiple scan locations or measurement points. Notably, each “scan location” or “measurement point” is not an infinitely small point in space, but rather a small and finite area of the scan field where one or more pulses impacts an object. The pulses of laser light reflect back from the scan locations or measurement points on the objects. The detector 104 is configured to receive these reflections of the laser light pulses from the scan locations or measurement points on objects within the scan field.

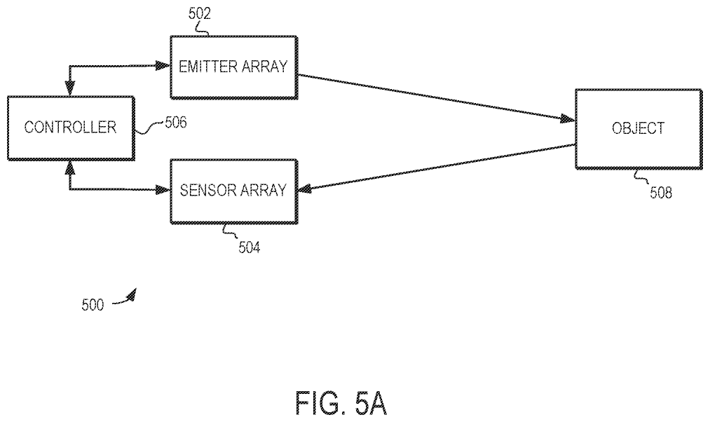

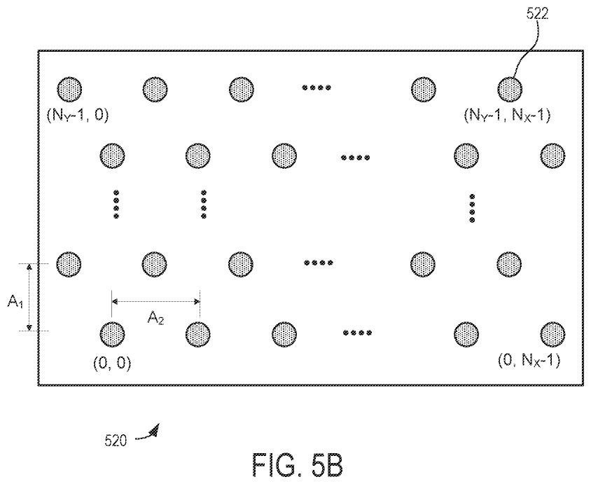

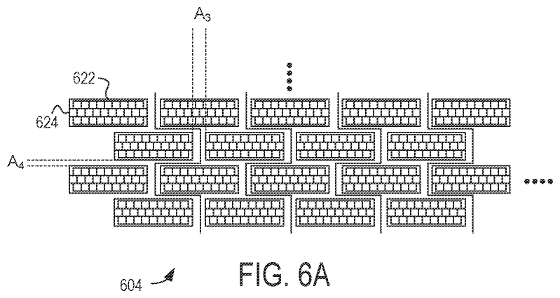

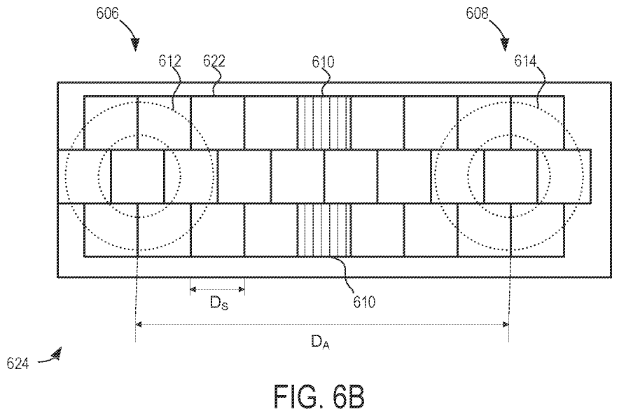

In one embodiment, the laser light source 102 comprises an array of emitter elements and the detector 104 comprises an array of sensor elements. In such embodiments, the array of emitter elements can be arranged in focal plane array configuration on the laser light source 102 and the array of sensor elements can be arranged in a corresponding focal plane array configuration on the detector 104. Such an embodiment will be described in greater detail below with reference to FIGS. 5-6.

In general, the at least one controller 106 controls the operation of the laser light source 102, detector 104 and can control other devices that are part of or coupled to the scanning laser device 100. Additionally, the at least one controller 106 can perform the operations needed for object detection and/or 3D map generation based at least in part on the reflections received at the detector 104.

For example, the at least one controller 106 can use time-of-flight (TOF) measurements of the received reflections to generate measurement distances. As one specific example, these measurement distances can be used to generate 3-dimensional point clouds that describe the depth or distance at each point, and thus can be used to generate a depth map of any detected objects (e.g., object 108). And as will be described in greater detail below, the at least one controller 106 can be implemented to determine radial velocity estimates for measurement points using distance measurements from a frame of distance measurements and the time delta between subframes.

As used herein, the term “radial velocity estimate” is an estimate for that component of (or contribution to) the object velocity along the laser-light direction relative to the scanning laser device 100. Stated another way, the estimated radial velocity is an estimate of the object velocity at a measurement point on the object, where the radial velocity is referenced along a vector between the scanning laser device and the measurement point. As will be discussed in greater detail below, the embodiments described herein can provide a radial velocity estimate for each of a plurality of measurement points on an object for each measurement frame.

The at least one controller 106 can be implemented with any suitable combination of hardware and/or software. For example, the at least one controller 106 can be implemented with a variety of processing devices, including one or more digital processors, one or more programmable controllers, specialized hardware devices, and any combination therein.

In accordance with the embodiments described herein, the at least one controller 106 is adapted to determine radial velocity estimates for measurement points using distance measurements from frames of distance measurements. For example, the at least one controller 106 can be adapted to scan first measurement points with laser light pulses to generate a first plurality of distance measurements for a first measurement subframe based on times-of-flight of detected reflections, and to scan second measurement points with laser light pulses to generate a second plurality of distance measurements for a second measurement subframe based on times-of-flight of detected reflections. In such a process each measurement subframe generates only a portion of the measurement data for a frame, and thus the full frame of measurement data is only available in the composition of the subframes that make up the frame. Thus, in this example, the first measurement subframe and the second measurement subframe together provide the measurement data for the full measurement frame. Notably, the first measurement subframe and the second measurement subframe are part of the same measurement frame (e.g., the first measurement subframe and the second measurement subframe are temporally adjacent subframes that together comprise one measurement frame).

The at least one controller 106 is further adapted to interpolate the first plurality of distance measurements to determine a first plurality of distance estimates. Specifically, this interpolation of distance measurements generates distance estimates for points not directly scanned during the first measurement subframe. The at least one controller 106 is further adapted to compare the generated distance estimates in the first plurality of distance estimates to distance measurements in the second plurality of distance measurements and to determine radial velocity estimates for corresponding measurement points based on the comparison.

As was noted above, the first measurement subframe and the second measurement subframe are part of the same measurement frame. For example, the first measurement subframe and the second measurement subframe can be temporally adjacent subframes that together comprise one measurement frame. Thus, for each scanned frame the at least one controller 106 can provide velocity estimates for multiple measurement points. Again, this estimation of velocity for multiple measurement points for each scanned frame can provide such velocity information with relatively low latency and high frequency. Furthermore, in some embodiments the velocity information for each frame can facilitate object tracking or perception algorithms. For example, the velocity information can be used in generating dynamic occupancy grids to distinguish between stationary and moving objects with greater certainty, which can improve the quality and safety of the perception results.

In one more specific embodiment, the at least one controller can be further adapted to interpolate second distance measurements in the second plurality of distance measurements to determine a second plurality of distance estimates and to compare distance estimates in the second plurality of distance estimates to distance measurements in the first plurality of distance measurements to determine radial velocity estimates for corresponding measurement points.

In another more specific embodiment, the at least one controller can be adapted to compare the distance estimates in the first plurality of distance estimates to the distance measurements in the second plurality of distance measurements to determine the radial velocity estimates for the corresponding measurement points by being further adapted to interpolate second distance measurements in the second plurality of distance measurements to determine a second plurality of distance estimates and compare the distance estimates in the first plurality of distance estimates to distance estimates in the second plurality of distance estimates to distance measurements in the first plurality of distance measurements to determine the radial velocity estimates for the corresponding measurement points.

In one more specific embodiment, the at least one controller can be further adapted to determine a surface-normal velocity from at least one of the radial velocity estimates. For example, the at least one controller can be adapted to determine a surface-normal vector of a surface at the measurement point and project the at least one radial velocity estimate onto the surface-normal vector.

In one more specific embodiment, the laser light source comprises an array of emitter elements. And in some embodiments this array of emitter elements is arranged in the focal plane of a transmitting lens or other optic. Detailed examples of such embodiments will be discussed below.

The scanning laser device 100 can be adapted to scan the laser light pulses in the scan region using a variety of techniques and patterns. Furthermore, a variety of different techniques and patterns can be used to interpolate the distance measurements to determine distance estimates and to compare the generated distance estimates to distance measurements to determine radial velocity estimates for corresponding measurement points based on the comparison.

Turning now to FIG. 1B, a scan pattern 112 in a scan field 114 is illustrated schematically. In the example of FIG. 1B the scan pattern 112 includes a plurality of measurement points 116 that are impacted by laser light pulses during a measurement frame. In this illustrated example the measurement points 116 in the scan pattern 112 are arranged in an array of rows and columns, although this is just one example of how such a scan pattern of measurement points can be implemented. For example, scan patterns can be implemented with the measurement points arranged in a circular manner, parameterized by radius and angle. As will be described in greater detail below, such scan patterns can be implemented using an array of emitter elements and a corresponding array of sensor elements. In these embodiments the array of emitter elements can be operated such that some portion of the emitter elements emit laser pulses nearly simultaneously, and a corresponding portion of sensor elements can receive reflections simultaneously. For example, in some embodiments one or more rows of emitter elements can be operated to emit laser pulses nearly simultaneously. In other embodiments a sub-portion of checkerboard or grid pattern of emitter elements can be operated to emit laser pulses nearly simultaneously. In such embodiments the scan patterns will be determined in part by the arrangement and simultaneous operation of these emitter elements and sensor elements.

Notably, the scan pattern 112 illustrates measurement points 116 that are scanned during one measurement frame. Stated another way, the distance measurements generated from the reflections of the laser light pulses from the measurement points 116 in scan pattern 112 provides one measurement frame of data.

Next, in this example the one measurement frame of data is generated during two measurement subframes. Turning now to FIG. 1C, scan patterns 118 and 120 for two exemplary subframes that can make up scan pattern 112 are illustrated separately. In this example scan patterns 118 and 120 each provide alternating rows of measurement points in the frame, where the alternating rows of measurement points are interleaved and be combined together to provide the overall scan pattern 112 for the measurement frame.

Specifically, in this illustrated example, the scan pattern 118 includes a plurality of measurement points 122 that are impacted by laser light pulses during a first measurement subframe. The measurement points 122 for this first measurement subframe are in alternating rows of the overall scan pattern 112. Again, the measurement points 122 can be measured by emitting laser light pulses from emitter elements in alternating rows of emitter elements and receiving reflections at corresponding sensor elements for the first subframe.

Likewise, the scan pattern 120 includes a plurality of measurement points 124 that are impacted by laser light pulses during a second measurement subframe. Again, the measurement points 124 for this second measurement subframe are in alternating rows of the overall scan pattern 112. And again, the measurement points 124 can be measured by emitting laser light pulses from emitter elements in alternating rows of emitter elements and receiving reflections at corresponding sensor elements for the second subframe.

Thus, taken together the scan patterns 118 and 120 for the first and second subframes provide the full scan pattern 112 of the overall measurement frame. Stated another way, the scan patterns 118 and 120 are spatially complementary.

Notably, one frame of measurement data is generated during two temporally adjacent subframes. For example, the laser light pulses for scan pattern 118 can be emitted for a first subframe of measurements and then the laser light pulses for scan pattern 120 can be emitted for a second subframe of measurements, where the laser light pulses for second subframe are emitted immediately following (or immediately before) the emission of the laser light pulses for the first subframe. Stated another way, the first and second subframes are temporally adjacent subframes that together provide one full frame of measurement data from the measurement points 116. Again, it should be noted that the order of first and second subframes can be different in various embodiments. Specifically, in some embodiments the first subframe precedes and it is temporally adjacent to the second subframe, while in other embodiments the second subframe precedes and it is temporally adjacent to the first subframe.

Turning now to FIG. 1D, a scan pattern 123 in a scan field 125 is illustrated schematically. In the example of FIG. 1D the scan pattern 123 includes a plurality of measurement points 126 that are impacted by laser light pulses during a measurement frame. In this illustrated example the measurement points 126 in the scan pattern 123 are arranged in array of rows and columns, although again this is just one example of how such a scan pattern of measurement points can be implemented.

Again, the scan pattern 123 illustrates measurement points 126 that are scanned during one measurement frame. Stated another way, the distance measurements generated from the reflections of the laser light pulses from the measurement points 126 in scan pattern 123 provides one measurement frame of data.

Again, in this example the one measurement frame of data is generated during two measurement subframes. Turning now to FIG. 1E, scan patterns 128 and 130 for two exemplary subframes that can make up scan pattern 123 are illustrated separately. In this example scan patterns 128 and 130 each provide alternating an alternating grid or checker pattern of measurement points, where the alternating grid or checker patterns of measurement points are interleaved and be combined together to provide the overall scan pattern 123 for the measurement frame.

Specifically, in this illustrated example, the scan pattern 128 includes a plurality of measurement points 126 that are impacted by laser light pulses during a first measurement subframe. The measurement points 126 for this first measurement subframe are in an alternating grid pattern. Again, the measurement points 126 can be measured by emitting laser light pulses from emitter elements in a grid pattern of emitter elements and receiving reflections at corresponding sensor elements for the first subframe.

Likewise, the scan pattern 130 includes a plurality of measurement points 127 that are impacted by laser light pulses during a second measurement subframe. Again, the measurement points 127 for this second measurement subframe are in alternating grid pattern of the overall scan pattern 123. And again, the measurement points 127 can be measured by emitting laser light pulses from emitter elements in an alternating grid pattern of emitter elements and receiving reflections at corresponding sensor elements for the second subframe.

Notably, in this embodiment the first alternating grid pattern of measurement points 126 and the second alternating grid pattern of measurement points 127 are interleaved together.

Thus, taken together the scan patterns 128 and 130 for the first and second subframes provide the full scan pattern 123 of the overall measurement frame. And again, in this example one frame of measurement data is generated during two temporally adjacent subframes. For example, the laser light pulses for scan pattern 128 can be emitted for a first subframe of measurements and then the laser light pulses for scan pattern 130 can be emitted for a second subframe of measurements, where the laser light pulses for second subframe are emitted immediately following the emission of the laser light pulses for the first subframe. Stated another way, the first and second subframes are temporally adjacent subframes that together provide one full frame of measurement data from the measurement points 126 and 127.

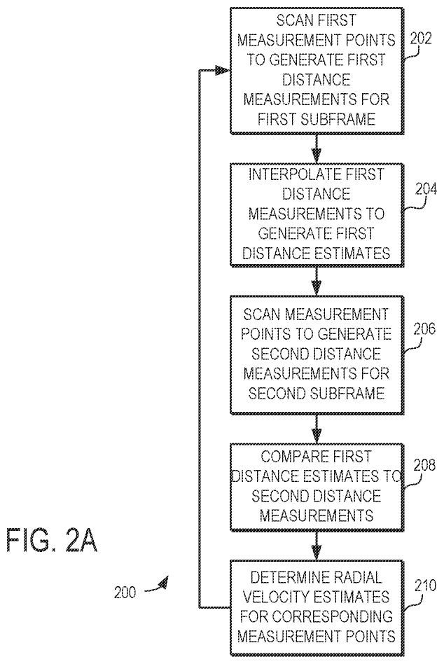

Turning now to FIG. 2A, a flow diagram illustrates a method 200 in accordance with various embodiments. In some embodiments, method 200, or portions thereof, is performed by a LiDAR or other scanning laser device (e.g., scanning laser device 100, 500). For example, method 200 can be performed by a series of circuits or an electronic system that is part of, in communication with, or otherwise associated with a scanning laser device. Thus, method 200 is not limited by the particular type of apparatus performing the method.

At step 202 first measurement points are scanned with laser light pulses to generate a first plurality of distance measurements for a first measurement subframe based on times-of-flight of detected reflections. As described above, in one embodiment step 202 is performed with an array of emitter elements that can simultaneously transmit laser light pulses and a corresponding array of sensor elements that can simultaneously receive reflections of the pulses for each subframe. In such an embodiment the first plurality of distance measurements for a first measurement subframe will be determined in part by the arrangement and operation of these emitter elements and sensor elements.

In one example, step 202 is performed by emitting from emitter elements that correspond to alternating rows of measurement points and receiving reflections at corresponding sensor elements. In some embodiments, one or more alternating rows of emitter elements can be operated to emit laser pulses nearly simultaneously. For example, one row of emitter elements can be operated to simultaneously emit laser pulses, and then the next alternate row can be operated to simultaneously emit laser pulses, and so forth until the entire subframe has been completed. It should be noted that in these embodiments the time differences between rows in the same subframe can be relatively small compared to the time differences between subframes.

As another specific example, the array of emitter elements could transmit alternating row by alternating row, where each alternating row of emitters transmits simultaneously. In this example there is a time difference between each of the alternating rows of laser light pulses. This time difference between alternating rows can be relatively small compared to the overall difference between subframes. In some embodiments the time difference between alternating rows may be small enough that it can be ignored when generating distance estimates for the measurement points between the alternating rows. Stated another way, the laser pulses for two or more alternating rows used to generate the distance estimates for the subframe can be considered to be emitted nearly simultaneously when generating the distance estimates.

In other embodiments, all the alternating rows of emitter elements can be operated to emit laser pulses nearly simultaneously. In such an embodiment all the laser pulses for a subframe are emitted nearly simultaneously.

In another example, step 202 is performed by emitting from emitter elements that correspond to an alternating grid pattern of measurement points and receiving reflections at corresponding sensor elements. In some embodiments, sub-portions of a grid pattern or checkerboard of emitter elements can be operated to emit laser pulses nearly simultaneously, and then the next sub-portion can be operated to nearly simultaneously emit laser pulses, and so forth until the entire subframe has been completed. Again, in these embodiments the time differences between sub-portions of the grid pattern can be relatively small compared to the time differences between subframes.

As one specific example, sub-portions of the grid pattern can be transmitted simultaneously. Again, in such an example there is a time difference between each sub-portion of the alternating grid pattern, but again this time difference can be relatively small compared to the overall difference between subframes. Thus again, the time difference between sub-portions of the grid pattern may be small enough that it can be ignored when generating distance estimates for the measurement points. Stated another way, the laser pulses for two or more sub-portions of the grid pattern used to generate the distance estimates for the subframe can be considered to be emitted nearly simultaneously when generating the distance estimates.

In other embodiments, the entire alternating grid pattern of emitter elements can be operated to emit laser pulses nearly simultaneously. In such an embodiment all the laser pulses for a subframe are emitted nearly simultaneously.

Of course, these are just some examples of the types of scan patterns and implementations that may be used in generating the first plurality of distance measurements for the first subframe.

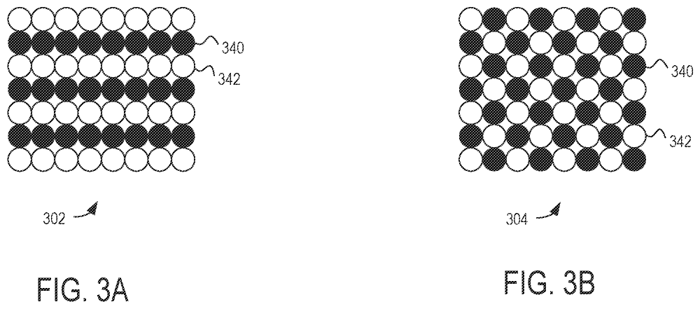

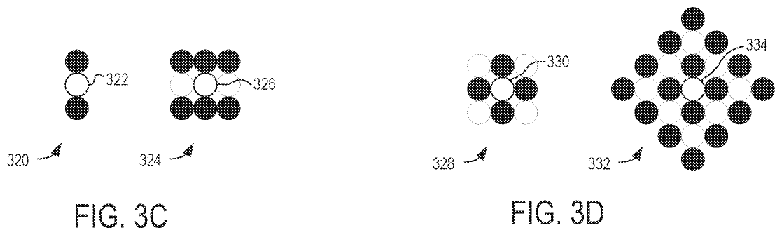

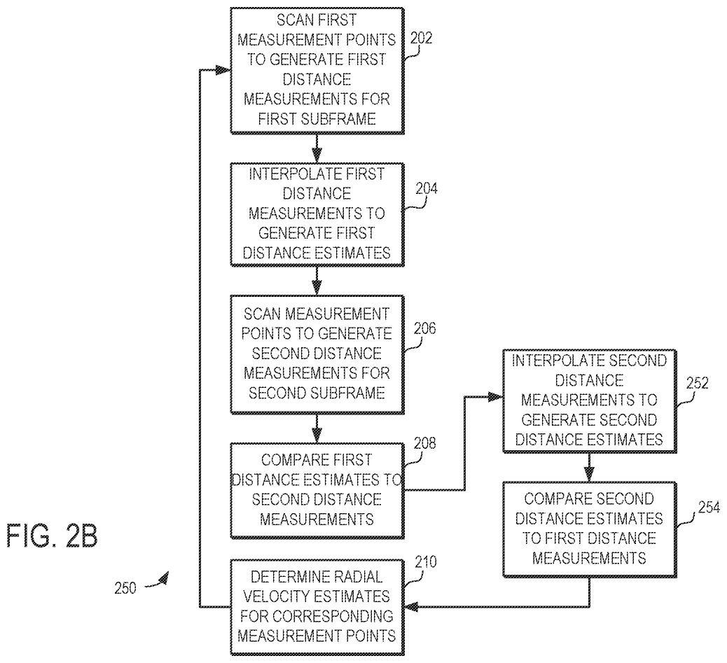

Turning briefly to FIGS. 3A and 3B, examples of such scan patterns are illustrated schematically. Specifically, FIG. 3A shows a portion of a scan pattern 302 where alternating rows of measurement points are scanned in the first subframe (e.g., during step 202 of method 200). In FIG. 3A the black circles 340 represent measurement points for which distance measurements are generated in the first subframe, while the white circles 342 represent measurement points that are not scanned in the first subframe. Thus, in FIG. 3A the black circles 340 represent alternating rows of measurement points that are simultaneously scanned (or scanned row by alternating row) by the emitter elements and for which reflections are received at corresponding sensor elements, and for which the received reflections are used to generate a first plurality of distance measurements.

Likewise, FIG. 3B shows a portion of a scan pattern 304 where an alternating grid pattern of measurement points are scanned in the first subframe (e.g., during step 202 of method 200). In FIG. 3B the black circles 340 again represent measurement points that are scanned in the first subframe, while the white circles 342 represent measurement points that are not scanned in the first subframe. Thus, in FIG. 3B the black circles 340 represent an alternating grid pattern of measurement points that are simultaneously scanned (or scanned sub-grid by alternating sub-grid) by the emitter elements and for which reflections are received at corresponding sensor elements, and for which the received reflections are used to generate a first plurality of distance measurements.

Returning to FIG. 2A and method 200, at step 204 the first plurality of distance measurements are interpolated to generate a first plurality of distance estimates. In this step the interpolation of distance measurements is used to generate first distance estimates for measurement points not scanned during the first measurement subframe. In the examples of FIGS. 3A and 3B this corresponds to measurement points represented with white circles 342. Stated another way, the distance measurements for measurement points scanned in the first subframe (represented with black circles 340) are used to generate distance estimates for measurement points not scanned in the first subframe (represented with white circles 342). Consequently, the distance measurements for measurement points scanned in the first subframe are used to generate distance estimates for measurement points not scanned in the first subframe but will be scanned in the second subframe. However, it should be noted that in some implementations of step 204 distance estimates are not generated for all measurement points that were not scanned in the first subframe, and instead distance estimates may only be generated for a subset of the unscanned measurement points.

In general, step 204 uses interpolation to generate distance estimates for measurement points using the first distance measurements for neighboring or nearby measurement points that were scanned in step 202. A variety of different techniques can be used to perform the interpolations of step 204. For example, a variety of linear and planer interpolation techniques may be used to generate the distance estimates. As other examples, non-linear interpolation, polynomial interpolation, feature extraction, or statistical techniques may be used generating distance estimates.

In various embodiments a variety of different combinations of distance measurements may be used in the interpolations of step 202. In these various embodiments different subsets of distance measurements from different “neighborhoods” having different “neighborhood sizes” may be used. For example, in some embodiments only distance measurements for directly adjacent measurement points can be used for interpolation. In other examples, distance measurements from other measurement points that are non-adjacent in the scan field may also be used. These other measurement points that are not adjacent to the current measurement point in the image plane are a farther distance from the current measurement point than adjacent measurement points but can still be used to interpolate and generate distance estimates for the current measurement point. And in other examples, distance measurements from measurement points at different relative angles and/or relative distances may be used. And in yet other examples, combinations of the above examples may be used.

Finally, it should be noted that the interpolation technique used in step 204 to generate the distance estimate would typically depend on the number of distance measurements used and the relative positioning of those distance measurements. For example, distance measurements from closer measurement points can be weighted higher than those from farther measurement points.

Turning briefly to FIGS. 3C and 3D, examples of distance measurements that may be used for interpolation are illustrated schematically. Specifically, FIG. 3C shows examples 320, 324 of measurement points from an alternating row pattern, where the black circles represent measurement points for which first distance measurements can be used to interpolate a first distance estimate for the measurement point represented by the white circles 322, 326.

Specifically, in example 320 distance measurements for two adjacent measurement points are used to generate the distance estimate for measurement point indicated by white circle 322. In example 324 distance measurements for two directly adjacent measurement points and four diagonally adjacent measurement points are used to generate the distance estimate for measurement point indicated by white circle 326. Again, these are just two examples, and many other implementations and configurations are possible.

FIG. 3D likewise shows examples 328, 332 of measurement points from a grid pattern, where the black circles again represent measurement points for which distance measurements can be used to interpolate a distance estimate for the measurement point represented by the white circles 330, 334.

In example 328 distance measurements for four adjacent measurement points are used to generate the distance estimate for the measurement point indicated by white circle 330. In example 332 distance measurements for four directly adjacent measurement points and twelve farther measurement points are used to generate the distance estimate for measurement point 334. Again, these other farther measurement points that are not directly adjacent to the current measurement point 334 in the scan region. Thus, these farther measurement points are a greater distance from the current measurement point 334 in the image plane (compared to the adjacent measurement points used in example 328) but can still be used to interpolate and generate distance estimates for the current measurement point 334. Again, these are just two examples, and many other implementations and configurations are possible.

At step 206 second measurement points are scanned with laser light pulses to generate a second plurality of distance measurements for a second measurement subframe based on times-of-flight of detected reflections. In this step, the second measurement points scanned in step 206 include or correspond to at least some of the measurement points for which distance estimates were generated in step 204.

Again, in one embodiment step 206 is performed with an array of emitter elements that can simultaneously transmit laser light pulses (e.g., row-by-row, grid-by-grid transmission) and a corresponding array of sensor elements that can simultaneously receive reflections of the pulses for each subframe. For example, step 206 can be performed by simultaneously emitting from emitter elements that correspond to alternating rows of measurement points and receiving reflections at corresponding sensor elements. In this example, step 206 would typically comprise emitting from emitter elements that correspond to rows not scanned in step 202. For example, returning to FIG. 3A, step 206 could be performed by emitting laser pulses from emitter elements that correspond to the measurement points represented by white circles 342.

In another example, step 206 is performed by simultaneously emitting from emitter elements that correspond to an alternating grid pattern of measurement points and receiving reflections at corresponding sensor elements. In this example, step 206 would typically comprise emitting from emitter elements that correspond to a grid pattern of measurement points not scanned in step 202. For example, returning to FIG. 3B, step 206 could be performed by emitting laser pulses from emitter elements that correspond to the measurement points represented by white circles 342.

In either case, the second measurement points scanned in step 206 include or correspond to at least some of the measurement points that were not scanned in step 202 and for which distance estimates were generated in step 204.

And again, it should be noted that the first measurement subframe scanned in step 202 and the second measurement subframe scanned in step 206 are part of the same measurement frame (e.g., the first measurement subframe and the second measurement subframe are temporally adjacent subframes that together comprise one measurement frame).

At step 208 the generated first distance estimates in the first plurality of distance estimates are compared to distance measurements in the second plurality of distance measurements. Notably, in step 208 the distance estimates for each of a plurality of measurement points during one subframe are compared to the corresponding distance measurements made for those same measurement points during another subframe, where the subframes are part of the same measurement frame.

Thus, the plurality of distance measurements made in the first subframe (step 202) are used to generate a plurality of distance estimates (step 204), and a plurality of distance measurements made in the second subframe (step 206) are now each compared during to a corresponding distance estimate in the plurality of distance estimates during step 208.

Returning briefly to the examples of FIGS. 3A and 3B, distance measurements made in the first subframe for the measurement points represented by black circles 340 (generated in step 202) are used to generate a plurality of distance estimates for the measurement points represented by white circles 342 (in step 204). Distance measurements are made in the second subframe for the measurement points represented by white circles 342 (in step 206). In step 208 the plurality of distance estimates generated are now each compared to a corresponding distance measurement made in the second subframe. Thus in this example, for each measurement point represented by a white circle 342, a distance measurement from one subframe is compared to a distance estimate generated from another subframe.

In step 208 the distance measurements and distance estimates can be compared in various ways. For example, step 204 can be performed by determining the difference between each distance estimate and the corresponding distance measurement for the same measurement point. In some embodiments additional information can be used in step 204. For example, the relative “intensity” of received reflections may be used in some determinations.

At step 210 radial velocity estimates are determined for corresponding measurement points based on the comparison. In general, step 210 can be performed by determining a radial velocity estimate for each of a plurality of measurement points. Thus, for each of a plurality of measurement points a comparison of the distance measurement to the distance estimate for that point can be performed, and a radial velocity estimate for that point determined from the comparison.

As one example, where the comparison in step 208 generates a distance difference between each distance estimate and the corresponding distance measurement, that distance difference and the time delta between the time of the first distance measurement (in step 202) and the second distance measurement (in step 206) can be used to generate a radial velocity estimate for the corresponding measurement point. Notably, in this example the time delta between measurements is also the time period between the temporally adjacent subframes.

Returning briefly to the examples of FIGS. 3A and 3B, distance differences for each measurement point represented by a white circle 342 can be generated in step 208 from the distance estimate generated in step 204 and the second distance measurement generated in step 206, and those distance differences can be used to generate radial velocity estimate for each measurement point represented by a white circle 342.

Steps 202, 204, 206, 208 and 210 can be continuously repeated to generate radial velocity estimates for corresponding measurement points. Notably, this technique facilitates the determination of radial velocity estimates for each of a plurality of measurement points during each scan frame.

It should be noted that order of the steps illustrated in FIG. 2A are merely illustrative of one example and can be modified in other embodiments. For example, in some embodiments, step 206 can be before step 204. Furthermore, in various embodiments one or more steps can be performed simultaneously. For example, step 204 can be performed during times when step 206 is also being performed. Likewise with steps 208 and 210. Thus, it should be understood that the order illustrated in FIG. 2A is just one example embodiment, and that other embodiments are possible.

In some embodiment, the method 200 of FIG. 2A can be expanded to generate radial velocity estimates for more measurement points. Specifically, while method 200 as described above effectively generates radial velocity estimates for a portion of the measurement points (i.e., those points for which distance estimates were generated in step 202), the method 200 can be expanded to generate more measurement points by interpolating distance estimates for more measurement points and comparing those distance estimates to more distance measurements and using that comparison to generate more radial velocity estimates. As one example, the method 200 can be expanded to also generate radial velocity elements for at least a plurality of measurement points represented by black circles in FIGS. 3A and 3B.

Turning now to FIG. 2B, a flow diagram illustrates a method 250 in accordance such embodiments. Again, this method 250, or portions thereof, is performed by a LiDAR or other scanning laser device (e.g., scanning laser device 100, 500). Compared to method 200, the method 250 adds additional steps to generate more radial velocity estimates for more measurement points.

Specifically, method 250 includes the steps 202, 204, 206, 208 and 210 as described above. However, method 250 also includes additional steps 252 and 254 between steps 208 and 210. In step 252 a second plurality of distance measurements are interpolated to generate a second plurality of distance estimates. Specifically, in this step 252 the interpolation of distance measurements is used to generate second distance estimates for measurement points that were not estimated in the previous step 204 and not directly scanned during the second measurement subframe in the previous step 206. In the examples of FIGS. 3A and 3B this corresponds to measurement points represented with black circles 340. Stated another way, the distance measurements for measurement points scanned in the second subframe (represented with white circles 342) are used to generate distance estimates for measurement points not scanned in the second subframe (represented with black circles 340). However, it should again be noted that in some implementations of step 252 distance estimates are not generated for all measurement points that were not scanned in the second subframe, and instead distance estimates may only be generated for a subset of the unscanned measurement points.

Again, step 252 uses interpolation to generate a distance estimate for each of these measurement points using the second distance measurements generated for neighboring or nearby measurement points that were scanned in step 206. And as with step 204, a variety of different techniques can be used to perform the interpolations of step 252 (including those illustrated in FIGS. 3C and 3D).

At step 254 the generated second distance estimates in the second plurality of distance estimates are compared to distance measurements in the first plurality of distance measurements. Again, in step 254 the distance estimates for each of a plurality of measurement points during one subframe are compared to the corresponding distance measurements made for those same measurement points during another subframe, where the subframes are part of the same measurement frame.

Thus, the plurality of distance measurements made in the first subframe (step 202) are used to generate a plurality of distance estimates (step 204), and a plurality of distance measurements made in the second subframe (step 206) are each compared to a corresponding distance estimate in the plurality of distance estimates during step 208. And the plurality of distance measurements made in the second subframe (step 206) are used to generate a second plurality of distance estimates (step 252), and a plurality of distance measurements made in the first subframe (step 202) are each compared to a corresponding distance estimate in the second plurality of distance estimates during step 254.

At step 210 radial velocity estimates are determined for corresponding measurement points based on the comparison as was described with reference to method 200 above. Again, step 210 can be performed by determining a radial velocity estimate for each of a plurality of measurement points. Thus, for each of a plurality of measurement points a comparison of the distance measurement to the distance estimate for that point can be performed, and a radial velocity estimate for that point determined from the comparison.

Returning briefly to the examples of FIGS. 3A and 3B, distance differences for each measurement point represented by a white circle 342 can be generated in step 208 from the distance estimate generated in step 204 and the second distance measurement generated in step 206. Likewise, distance differences for each measurement point represented by a black circle 340 can be generated in step 254 from the distance estimate generated in step 252 and the first distance measurement generated in step 202. Those distance differences can be used to generate radial velocity estimate for each measurement point represented by a white circle 342 or a black circle 340.

Steps 202, 204, 206, 208, 252, 254 and 210 can be continuously repeated to generate radial velocity estimates for corresponding measurement points. Notably, this technique facilitates the determination of radial velocity estimates for each of a plurality of measurement points during each scan frame.

As described above, various techniques can be used to determine radial velocity estimates for each of a plurality of measurement points during each measurement frame. And as also described above, these radial velocity estimates each provide a measure of the object velocity at the corresponding measurement point on the object, where the radial velocity is referenced along a vector between the scanning laser device and the measurement point. However, a variety of other measurements and estimates can also be determined in various embodiments.

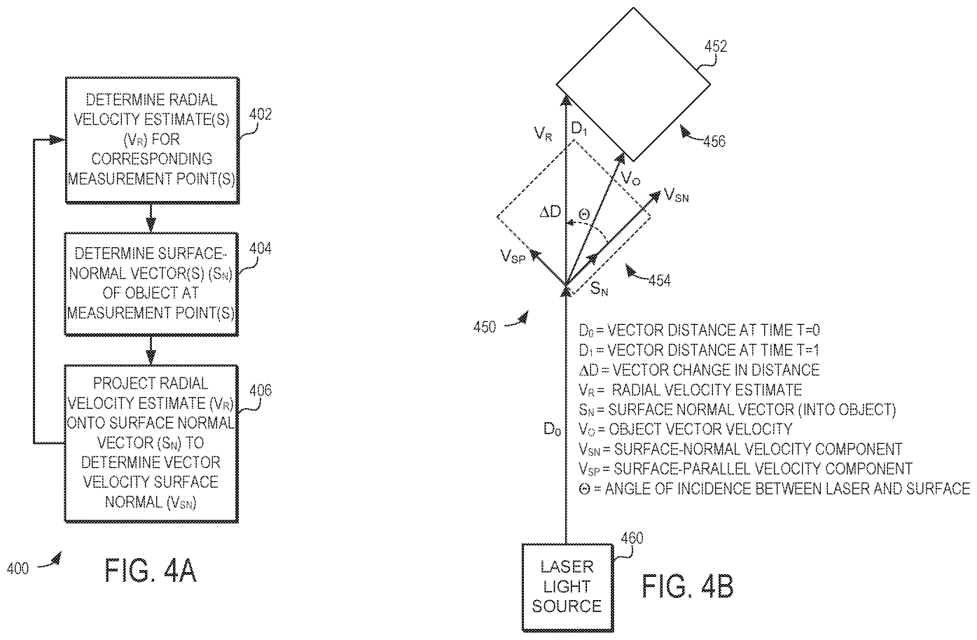

Turning now to FIGS. 4A and 4B, a method 400 and schematic diagram 450 illustrate a technique for determining a measure of velocity of a surface of the object. Specifically, the method can facilitate the determination of a normal component of surface velocity, referred to herein as a surface-normal velocity (V_{SN}).

Beginning with FIG. 4A and method 400, in step 402 radial velocity estimate(s) (V_{R}) for one or more measurement points are determined. In general, these radial velocity estimate(s) can be determined for the measurement points(s) on an object using any of the techniques described herein, including methods 200 and 250 described above. Thus, the radial velocity estimates (V_{R}) can be determined from scans of measurement points during first and second measurement subframes, distance measurements and distance estimates determined from those scans, and comparisons of the generated distance estimates to distance measurements.

Turning now to FIG. 4B, a schematic diagram 450 illustrates an example top view of an object moving from position 454 at time T=0 to a second position 456 at time T=1. In this example, a first distance D₀ at time T=0 is determined by a first distance measurement or first distance estimate. Likewise, a second distance D₁ at time T=1 is determined by a second distance estimate or second distance measurement. A change in the distance between first distance D₀ and second distance D₁ is represented as ΔD. Notably, in this example the time T=0 corresponds to a first subframe of measurements, and time T=1 corresponds a second subframe of measurements. Thus, the change in distance ΔD can be determined in one measurement frame and used to determine the radial velocity estimate (V_{R}). Again, this radial velocity estimate (V_{R}) is referenced along a vector between the laser light source 460 and the measurement point on the object 452.

Returning to FIG. 4A, in step 404, a surface-normal vector(s) (S_{N}) of the object is determined for the measurement point(s). In general, the surface-normal vector (S_{N}) for a measurement point can be determined from the distance measurements for a group of surrounding measurement points. For example, a group of three or more distance measurements for nearby measurement points can be used to determine a surface plane, where the surface is plane is defined as the plane passing through the group of points determined from the distances. And likewise, a surface-normal vector (S_{N}) that corresponds to the object surface at the measurement point can be determined from the distances to the nearby measurement points.

Returning to FIG. 4B, the schematic diagram 450 illustrates an example of a surface-normal vector (S_{N}) for a measurement point. Again, this surface-normal vector (S_{N}) for a measurement point can be determined from the distance measurements for a group of surrounding measurement points.

Returning to FIG. 4A, in step 406 the radial velocity estimate (V_{R}) for a measurement point is projected onto the surface-normal vector (S_{N}) for the measurement point to determine a surface-normal velocity (V_{SN}) of the measurement point. In this step, vector algebra can be used to perform the projection and determine the surface-normal velocity (V_{SN}) of a measurement point from the radial velocity estimate (V_{R}) and the surface-normal vector (SN).

Returning to FIG. 4B, the schematic diagram 450 illustrates an example of a surface-normal velocity (V_{SN}) of the measurement point determined by projecting the radial velocity estimate (V_{R}) for a measurement point onto the surface-normal vector (S_{N}). When determined, the surface-normal velocity (V_{SN}) of the measurement point can be used to provide a more accurate assessment of the object velocity. Specifically, the surface-normal velocity (V_{SN}) also provides velocity direction/orientation information that can be useful for some applications where it can be assumed that the object moves either parallel or perpendicular to the surface normal. Furthermore, in cases where two surfaces belong to the same object, the techniques can estimate both surface-normal velocities (V_{SN}) and can further compute the angle between those surfaces from the distance data, which can be then be used to determine the velocity vector of an object. And again, these determinations can be made from a single frame of data.

It should be noted that surface-normal velocity (V_{SN}) is just one example of the type of velocity that can be determined using the techniques described herein.

Turning now to FIG. 5A, a schematic diagram of a scanning laser device 500 in accordance various embodiments is illustrated. In one embodiment, the scanning laser device 500 is a light detection and ranging (LiDAR) system used for object detection and/or 3D map generation. In this embodiment the scanning laser device 500 includes an emitter array 502, a sensor array 504, and, and at least one controller 506. During operation, the emitter array 502 generates pulses of laser light that are projected into a spatial region referred to as a scan field. These pulses of laser light impact objects (e.g., object 508) in the scan field at multiple scan locations or measurement points. The pulses of laser light reflect back from the scan locations or measurement points on the objects. The sensor array 504 is configured to receive these reflections of the laser light pulses from the scan locations or measurement points on objects within the scan field.

In general, the at least one controller 506 controls the operation of the laser emitter array 502, the sensor array 504 and can control other devices that are part of coupled to the scanning laser device 500. Additionally, the at least one controller 506 can perform the operations needed for object detection and/or 3D map generation based at least in part on the reflections received at the detector 104.

In one specific embodiment the emitter array 502 comprises an array of emitter elements arranged in focal plane array configuration, and the sensor array 504 comprises an array of sensor elements arranged in a corresponding focal plane array configuration. For example, in each case the elements can essentially be arranged on one plane on a corresponding chip, with the plane arranged at a focal point of a corresponding optical element (e.g., an emitting optical lens or receiving optical lens).

In one particular embodiment, the emitter elements in the emitter array 502 comprise a plurality of vertical cavity surface emitting lasers (VCSELs), with the VCSELs distributed over a surface of an emission chip. In such an embodiment the sensor elements in the sensor array 504 can be constructed as an array of single photon avalanche diodes (SPADs), with the array of SPADs distributed over a surface of a receiver chip. In this case an emitting optical element directs the laser light pulses from the VCELs to the spatial region/scan field, and a receiving optical element directs received reflections from the spatial region/scan field to corresponding SPADs.

Each emitter element emits laser light pulses at a spatial angle which represents a part region of the spatial region, while the receiving optical element maps each sensor element onto a spatial angle which constitutes a part region of the spatial region. The number of all sensor elements covers the entire spatial region. In one embodiment, the emission elements and sensor elements which view the same spatial angle image to one another and are correspondingly assigned or allocated to one another. Normally, laser light of an emission element images onto the associated sensor element. A plurality of sensor elements are beneficially arranged inside the spatial angle of an emission element.

Time-of-flight (TOF) measurements of reflections received by the sensor elements are used by the at least one controller 506 to generate measurement distances. As one specific example, these measurement distances can be used to generate 3-dimensional point clouds that describe the depth or distance at each point, and thus can be used to generate a depth map of any detected objects (e.g., object 508). And as was described above, the at least one controller 506 can be implemented to determine radial velocity estimates for measurement points using distance measurements from a frame of distance measurements.

In one specific embodiment, the scanning laser device 500 uses a time correlated single photon counting (TCSPC) technique for detecting reflections from objects 508 in the spatial region. In this technique individual arriving photons of reflected laser light pulse are detected (e.g., by one of the SPADs in the sensor array 504) and the detection time (e.g., the triggering time) is stored. The time-of-flight of the arriving photon can be determined from the detection time and a reference time, at which the corresponding laser light pulse is emitted. From the time-of-flight the distance to the object in the spatial region from which the photon was reflected can be determined.

The scanning laser device 500 can use a variety of techniques to reduce the effects of ambient light and other noise on the detection of objects 508. In one embodiment multiple time-of-flight measurements are made during a measurement cycle and used to determine the distance to the object, where each measurement corresponds to the emission and subsequent detection of a pulse of laser light. These multiple times-of-flight can then be combined or used in a way that increases the ability to accurately determine the distance of objects.

For example, in one embodiment the results of multiple measurements made during a measurement cycle can be stored as a histogram, with the duration of the measuring cycle divided into relatively short time sections (commonly referred to as bins). In such an embodiment the value for a bin is increased for each detection that occurs in the corresponding time section. In one embodiment a time-to-digital converter (TDC) can be used to the store triggering times for each sensor element in a corresponding bin in a storage device. When multiple time-of-flight measurements are made over measurement cycle and the results stored in the corresponding bins, those bins with the highest values will then indicate the most likely true distance to the object.

Such a technique is particularly applicable to reducing the effects of noise caused by ambient radiation, as ambient radiation has the same likelihood of triggering a sensor element at any time and thus the effects of ambient radiation is likely to be spread evenly over the bins.

Turning now to FIG. 5B, an exemplary emitter array 520 is illustrated, where the emitter array 520 comprises a plurality of emitter elements 522. This emitter array 520 is an example of the type of laser light source that can be used in the various embodiments described herein. Specifically, as described above, in some embodiments the array of emitter elements 522 is arranged in focal plane array configuration, with the focal plane positioned at a focal point of a corresponding optical element (e.g., an emitting optical lens). In the example of FIG. 5B the plurality of emitter elements 522 are arranged in a grid type configuration, with the emitter elements 522 in rows and columns. It should be noted that the example of FIG. 5B is a simplified example for clarity of explanation, and that a typical implementation could include hundreds or thousands of emitter elements 522.

In the exemplary embodiment illustrated in FIG. 5B, the array of emitter elements 522 are configured in rows 0 to N_{Y}−1, with each row including emission Elements 0 to N_{X}−1. For example, 100 rows (N_{Y}=100) and 128 emission elements per row (N_{X}=128) may be provided. The row distance A₁ between the rows may lie in the range of a few micrometers, for example 40 μm. The element distance A₂ between emitter elements 522 in the same row may lie in a similar order of magnitude.

The array of emitter elements 522 can be configured and controlled to emit laser light pulses simultaneously from some portion or pattern of the emitter elements 522. For example, the emitter elements 522 can be configured and controlled to emit laser light pulses row-by-row, column-by-column, checkerboard-by-checkerboard, or any other suitable pattern. In each case, the emitter elements 522 can be configured and controlled to emit laser light pulses simultaneously in some portion of the emitter elements 522 and then to emit laser light pulses simultaneously in another portion of emitter elements 522.

For example, the emitter elements 522 can be configured and controlled to emit laser light pulses simultaneously from a first set of rows during a first measurement subframe and second set of rows during a second measurement subframe. Specifically, the emitter elements 522 can be configured and controlled to emit laser light pulses simultaneously from alternating rows or columns each measurement subframe. Likewise, the emitter elements 522 can be configured and controlled to emit laser light pulses simultaneously from alternating interlaced checkerboard patterns during first and second measurement subframes.

Turning now to FIGS. 6A and 6B, an exemplary sensor array 604 is illustrated, where the sensor array 604 comprises plurality of sensor elements 622 (note that for clarity in FIGS. 6A and 6B not all sensor elements 622 are indicated with the reference numeral). This sensor array 604 is an example of the type of detector that can be used in the various embodiments described herein.

As was described above, the plurality of sensor elements 622 can be arranged in a focal plane array configuration on the sensor array 604. For example, the plurality of sensor elements 622 can be arranged together in a plane on a corresponding sensor chip or other sensor device, with the plane positioned at a focal point of a receiving optical lens. Reflections of laser light pulses received at the receiving optical lens will then be focused on the corresponding sensor elements 622. It should be noted that FIG. 6A is a simplified example for clarity of explanation, with only a portion of sensor elements 622 illustrated compared to possible implementations. For example, an array of sensor elements could instead include hundreds or thousands of individual sensor elements 622.

In the embodiment of FIGS. 6A and 6B the sensor elements 622 are grouped together in rectangular sets of sensor elements 622. As will be described below, in this embodiment each rectangular set of sensor elements 622 includes two macro cells of sensor elements 622, and this grouping of macro cells can be referred to as a macro cell cluster 624. Specifically, each macro cell comprises those sensor elements 622 that are allocated together to receive reflections from the same emission element in the laser light source.

Referring now to FIG. 6B specifically, an enlarged view of an exemplary macro cell cluster 624 is illustrated. In this illustrated embodiment, the macro cell cluster 624 includes twenty eight sensor elements 622 that together make up two macro cells 606, 608. Furthermore, in this embodiment two sensor elements 610 with reduced sensitivity are arranged between the two macro cells 606, 608 or at the edge of one or both macro cells 606, 608. For example, the sensor elements 610 with reduced sensitivity may be formed with metallization on the opening or a reduced aperture so that fewer photons can be received. It should be understood that different numbers of sensor elements with reduced sensitivity may also be used in some embodiments.

In the illustrated example, two exemplary spot positions 612 and 614 are marked with dashed circles which represent desired locations of photons impacting the macro cells 606 and 608. Stated another way, the spot positions 612 and 614 indicate the sensor elements 622 that would be allocated to the macro cells 606 and 608 respectively.

Referring again to FIG. 6A, in this illustrated embodiment the macro cell clusters 624 are arranged in four rows. Again, it should be noted that this is just a simplified example, and that more rows would commonly be included. Next, it should be noted that the alternating rows macro cell clusters 624 are offset horizontally. Thus, between two rows of macro cell clusters 624 is an offset row of macro cell clusters 624. This offset between adjacent rows creates an interlaced pattern of sensor elements 622 that reduces presence of vertically blind regions in the array of sensor elements 622.

In the example of FIG. 6B each sensor element 622 has a width or diameter D_{S} and the distance D_{A} between macro cells 606 and 608. Notably, in this embodiment the distance D_{A} between macro cells 606 and 608 is a whole number multiple of the diameter D_{S} of the individual sensor elements 622.

In the preceding detailed description, reference was made to the accompanying drawings that show, by way of illustration, specific embodiments in which the invention may be practiced. These embodiments were described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The preceding detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

1. An apparatus comprising:
a laser light source configured to produce laser light pulses;
a detector to detect reflections of the laser light pulses from measurement points in a scan field;
at least one controller coupled at least the laser light source and the detector, the at least one controller adapted to:
scan first measurement points with laser light pulses to generate a first plurality of distance measurements for a first measurement subframe based on times-of-flight of detected reflections;
interpolate first distance measurements in the first plurality of distance measurements to determine a first plurality of distance estimates;
scan second measurement points with laser light pulses to generate a second plurality of distance measurements for a second measurement subframe based on times-of-flight of detected reflections; and
compare distance estimates in the first plurality of distance estimates to distance measurements in the second plurality of distance measurements to determine radial velocity estimates for corresponding measurement points.

2. The apparatus of claim 1, wherein the at least one controller is further adapted to:
interpolate second distance measurements in the second plurality of distance measurements to determine a second plurality of distance estimates; and
compare distance estimates in the second plurality of distance estimates to distance measurements in the first plurality of distance measurements to determine radial velocity estimates for corresponding measurement points.

3. The apparatus of claim 1, wherein the at least one controller is adapted to compare the distance estimates in the first plurality of distance estimates to the distance measurements in the second plurality of distance measurements to determine the radial velocity estimates for the corresponding measurement points by being adapted to:
interpolate second distance measurements in the second plurality of distance measurements to determine a second plurality of distance estimates; and
compare distance estimates in the second plurality of distance estimates to distance measurements in the first plurality of distance measurements to determine radial velocity estimates for corresponding measurement points.

4. The apparatus of claim 1, wherein the at least one controller is further adapted to determine a surface-normal velocity from at least one of the radial velocity estimates.

5. The apparatus of claim 1, wherein the at least one controller is further adapted to determine a surface-normal velocity from at least one of the radial velocity estimates by being adapted to:
determine a surface-normal vector of a surface at a measurement point; and
project the at least one radial velocity estimate onto the surface-normal vector.

6. The apparatus of claim 1, wherein the laser light source comprises a transmitting unit with an array of emitter elements and wherein the detector comprises a receiving unit with an array of sensor elements.

7. The apparatus of claim 6, wherein the array of emitter elements are configured in a first focal-plane array arrangement and wherein the array of sensor elements are configured in a second focal-plane arrangement.

8. The apparatus of claim 1, wherein the apparatus further comprises a time-of-flight (TOF) circuitry responsive to the detector to determine distances to the measurement points in the scan field from the detected reflections.

9. The apparatus of claim 1, wherein the first measurement subframe precedes and it is temporally adjacent to the second measurement subframe.

10. The apparatus of claim 1, wherein the second measurement subframe precedes and it is temporally adjacent to the first measurement subframe.

11. The apparatus of claim 1, wherein the first measurement subframe comprises alternating rows of measurement points and wherein the second measurement subframe comprises rows of measurement points interleaved with the alternating rows of measurement points.

12. The apparatus of claim 1, wherein the first measurement subframe comprises a first alternating grid pattern of measurement points and wherein the second measurement subframe comprises a second alternating grid pattern of measurement points interleaved with the first alternating grid pattern of measurement points.

13. A laser scanning method, where laser scanning method comprises:
scanning measurement points in a first measurement subframe with laser light pulses to generate a first plurality of distance measurements based on times-of-flight of detected reflections;
interpolating first distance measurements in the first plurality of distance measurements to determine a first plurality of distance estimates;
scanning measurement points in a second measurement subframe with laser light pulses to generate a second plurality of distance measurements based on times-of-flight of detected reflections; and
comparing distance estimates in the first plurality of distance estimates to distance measurements in the second plurality of distance measurements to determine radial velocity estimates for corresponding measurement points.

14. The method of claim 13, further comprising:
interpolating second distance measurements in the second plurality of distance measurements to determine a second plurality of distance estimates; and
comparing distance estimates in the second plurality of distance estimates to distance measurements in the first plurality of distance measurements to determine radial velocity estimates for corresponding measurement points.

15. The method of claim 13, wherein the comparing the distance estimates in the first plurality of distance estimates to the distance measurements in the second plurality of distance measurements to determine the radial velocity estimates for the corresponding measurement points comprises:
interpolating second distance measurements in the second plurality of distance measurements to determine a second plurality of distance estimates; and
comparing distance estimates in the second plurality of distance estimates to distance measurements in the first plurality of distance measurements to determine radial velocity estimates for corresponding measurement points.

16. The method of claim 13 further comprising determining a surface-normal velocity from at least one of the radial velocity estimates.

17. The method of claim 13, further comprising:
determining a surface-normal vector of a surface at a measurement point from at least one radial velocity estimate; and
projecting the at least one radial velocity estimate onto the surface-normal vector to determine a surface-normal velocity.

18. The method of claim 13 the laser light pulses are generated by a transmitting unit with an array of emitter elements configured in a first focal-plane array arrangement and wherein the detected reflections are detected with a receiving unit with an array of sensor elements configured in a second focal-plane arrangement.

19. The method of claim 13, wherein the first measurement subframe comprises alternating rows of measurement points and wherein the second measurement subframe comprises rows of measurement points interleaved with the alternating rows of measurement points.

20. The method of claim 13, wherein the first measurement subframe comprises a first alternating grid pattern of measurement points and wherein the second measurement subframe comprises a second alternating grid pattern of measurement points interleaved with the first alternating grid pattern of measurement points.
